(19) United States
(12) Patent Application Publication
(10) Pub. No.: US 2006/0077801 A1
(43) Pub. Date: Apr. 13, 2006

(54) METHOD AND DEVICE FOR TRACKING AND FOCUSING ENHANCEMENT OF DISK DRIVES

(76) Inventors: Yi-Chen Tseng, Hsin-Chu City (TW); Ching-Chuan Hsu, Hsin-Chu Hsien (TW); Shun-Yung Wang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,408

(22) Filed: Sep. 9, 2005

(30) Foreign Application Priority Data
Sep. 14, 2004 (TW) 093127767

(51) Int. Cl. G11B 7/00

(52) U.S. Cl. 369/44.27; 369/44.34

(57) ABSTRACT

A method for tracking and focusing enhancement of disk drives and related devices. The method performs feedforward compensation for an output signal generated by a feedback compensator of a disk drive. The output signal is utilized for controlling a tracking position or a focusing position of a read/write module of the disk drive. The method includes obtaining the output signal, within which a dominant signal is a periodic wave corresponding to a tracking error or a focusing error of the disk drive, identifying a waveform of the dominant signal, generating a correction signal according to the waveform of the dominant signal, and superposing the correction signal on the output signal to correct the dominant signal.

### BACKGROUND

The present invention relates to a feedforward compensation method and a related device for tracking and focusing enhancement of disk drives.

In a typical disk drive 100 shown in FIG. 1, a control circuit 105 of a read/write (R/W) module 120 typically comprises a feedback compensator 110 for correcting a radial error Er or a vertical error Ev of the R/W module 120 with respect to a reference position such as a specific position on a track 103 of a disk 102 accessed by the disk drive 100, where the radial error Er is also referred to as the tracking error, i.e. a position error along a radial direction 102r of the disk 102, and the vertical error Ev is a position error along a vertical direction 102v parallel to the rotational axis 102a of the disk 102. If the disk drive 100 and the disk 102 are respectively an optical disk drive and an optical disk, the vertical error Ev is called the focusing error.

The R/W module 120 of the related art comprises an optical pickup (OPU) 120p for reading data stored on the disk 102, and a driving unit 120d for driving the OPU 120p. The R/W module 120 is capable of generating a tracking error signal TE and a focusing error signal FE respectively corresponding to the tracking error and the focusing error mentioned above. In FIG. 1, the tracking error signal TE and the focusing error signal FE are represented by a general error signal 114. The tracking error occurs for a variety of probable reasons including runout of the disk 102, runout of a spindle motor of the disk drive 100, track shape abnormality, and/or radial interference to the R/W module 120 due to some other reasons, and therefore the R/W module 120 cannot lock onto a central position of the track 103. A typical example of the track shape abnormality mentioned above is a weaving track shape. On the other hand, the probable reasons why the focusing error occurs include wobble of the disk 102, distorted or uneven shape of the disk 102, and/or vertical interference to the R/W module 120 due to some other reasons, and therefore when focusing, the R/W module 120 cannot lock onto an ideal focusing position.

The feedback compensator 110 is capable of adjusting a position driving signal 112, which is utilized for controlling the R/W module 120, according to the error signal 114 to reduce the tracking error or the focusing error. As shown in FIG. 2, a well known method for the feedback compensator 110 to adjust the position driving signal 112 is superposing a dominant signal Sd corresponding to the error signal 114 on the position driving signal 112 to reduce the tracking error or the focusing error, where the magnitude of the dominant signal Sd corresponds to the error signal 114. If the feedback compensator 110 is a tracking compensator, an output signal 116 thereof is a tracking compensator output TRO well known in the art. If the feedback compensator 110 is a focusing compensator, the output signal 116 thereof is a focusing compensator output FOO well known in the art.

The ability of the feedback compensator 110 to correct the tracking error or the focusing error is typically limited by the response of the feedback compensator 110 to the tracking error or the focusing error. That is, when a phase delay phenomenon exists during the aforementioned operation of superposing the dominant signal Sd, the feedback compensator 110 cannot bring the compensation ability thereof into full play in real time due to the phase delay phenomenon, and in some instances, the phase delay phenomenon causes improper compensation.

### SUMMARY

According to one embodiment of the claimed invention, a method for tracking and focusing enhancement of disk drives is disclosed. The method is utilized for performing feedforward compensation for a first output signal generated by a feedback compensator of a disk drive. The first output signal is utilized for controlling a tracking position or a focusing position of a read/write (R/W) module of the disk drive. The method comprises obtaining the first output signal. Within the first output signal is a dominant signal, which is a periodic wave corresponding to a tracking error or a focusing error of the disk drive. The method further comprises identifying a waveform of the dominant signal, generating a correction signal according to the waveform of the dominant signal, and superposing the correction signal on the first output signal to correct the dominant signal.

According to one embodiment of the claimed invention, a device for tracking and focusing enhancement of disk drives is disclosed. The device is utilized for performing feedforward compensation for a first output signal generated by a feedback compensator of a disk drive. The first output signal is utilized for controlling a tracking position or a focusing position of an R/W module of the disk drive. Within the first output signal is a dominant signal, which is a periodic wave corresponding to a tracking error or a focusing error of the disk drive. The device comprises a identification unit coupled to the feedback compensator for identifying a waveform of the dominant signal, a sinusoidal wave generator coupled to the identification unit for generating a correction signal according to the waveform of the dominant signal, and a superposing unit coupled to the feedback compensator and the sinusoidal wave generator for superposing the correction signal on the first output signal to correct the dominant signal.

According to one embodiment of the claimed invention, a device for tracking and focusing enhancement of disk drives is disclosed. The device is utilized for performing feedforward compensation for a first output signal generated by a feedback compensator of a disk drive. The first output signal is utilized for controlling a tracking position or a focusing position of an R/W module of the disk drive. Within the first output signal is a dominant signal, which is a periodic wave corresponding to a tracking error or a focusing error of the disk drive. The device comprises a low pass filter (LPF) coupled to the feedback compensator for generating a low pass signal according to the first output signal, a memory coupled to the LPF for storing waveform information of the low pass signal, and a first logic unit coupled to the memory for outputting a correction signal, wherein the correction signal corresponds to the waveform information stored in the memory. The device further comprises a superposing unit coupled to the feedback compensator and the first logic unit for superposing the correction signal on the first output signal to correct the phase delay of the dominant signal.

### BRIEF DESCRIPTION OF THE DRAWINGS

FIG. 1 illustrates a feedback compensator and operation thereof according to the related art.

FIG. 2 is a block diagram of the feedback compensator shown in FIG. 1.

FIG. 3 is a flowchart of a method for tracking and focusing enhancement of disk drives according to the present invention.

FIG. 4 is a block diagram of a feedforward compensation loop corresponding to the method shown in FIG. 3 according to a first embodiment of the present invention.

FIG. 5 is a block diagram of a feedforward compensation loop corresponding to the method shown in FIG. 3 according to a second embodiment of the present invention.

### DETAILED DESCRIPTION

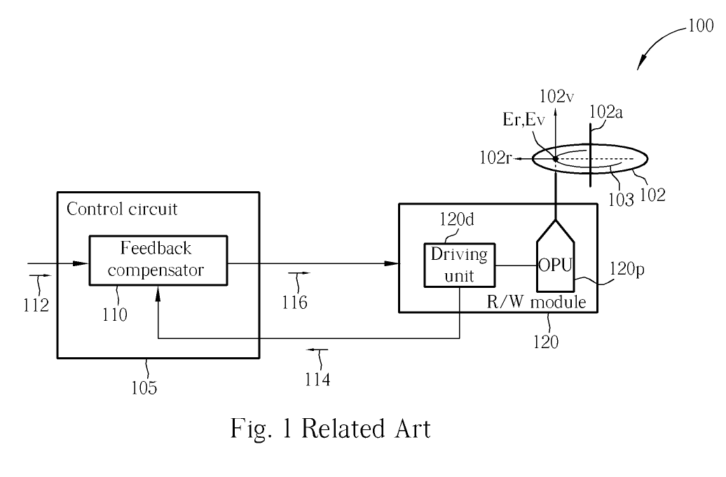

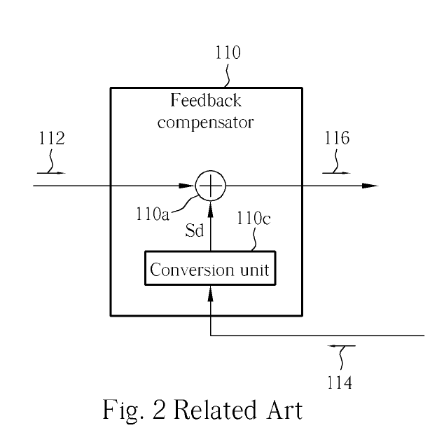

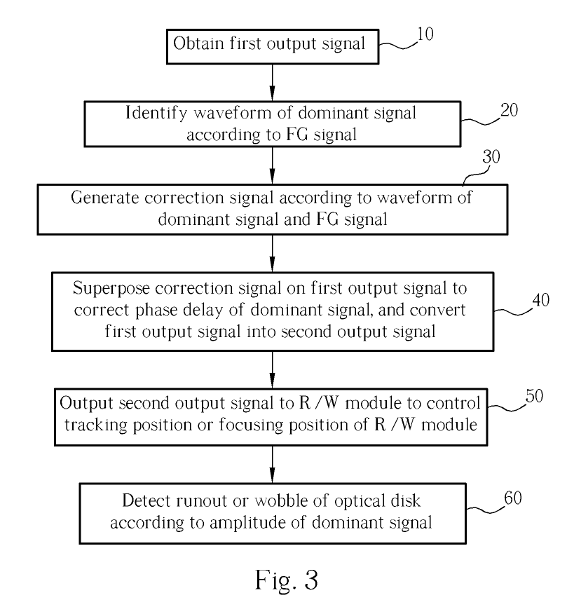

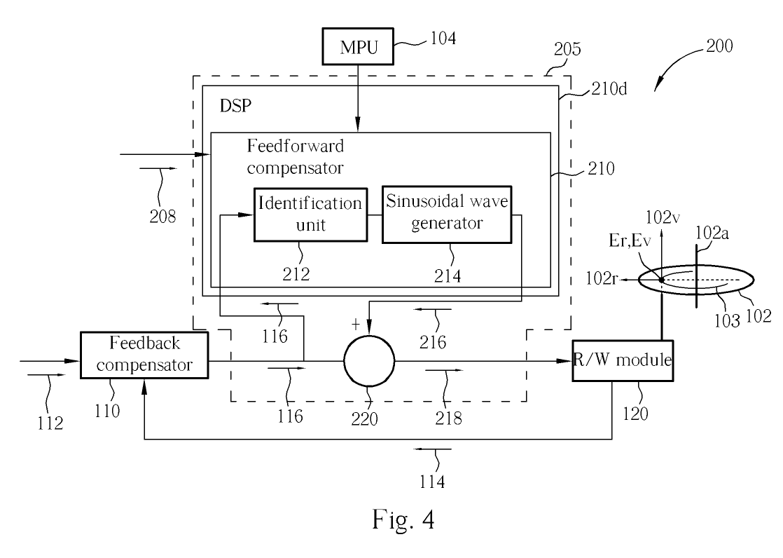

Although an optical disk drive is taken as an example in the following description, the present invention is also applicable to other kinds of disk drives. Please refer to FIG. 3 and FIG. 4. FIG. 3 is a flowchart of a method for tracking and focusing enhancement of disk drives according to the present invention. FIG. 4 illustrates a feedforward compensation loop 205 corresponding to the method shown in FIG. 3 and operation thereof according to a first embodiment of the present invention. The disk drive 200 shown in FIG. 4 comprises the aforementioned feedback compensator 110 and the R/W module 120, which have already been explained utilizing FIG. 1 and FIG. 2, where the feedback compensator 110 superposes the dominant signal Sd on the position driving signal 112 to generate the output signal 116, and there typically exists phase delay phenomenon during the operation of superposing the dominant signal Sd. The method and the feedforward compensation loop 205 are capable of correcting the phase delay phenomenon, so the feedback compensator 110 may bring the compensation ability thereof into full play in real time.

The feedforward compensation loop 205 of this embodiment comprises a feedforward compensator 210 and a superposing unit 220 as shown in FIG. 4. The feedforward compensator 210 comprises a identification unit 212 and a sinusoidal wave generator 214, which are implemented utilizing a digital signal processor (DSP) 210d in this embodiment. Within the disk drive 200, a microprocessor 104, which is a micro-processing unit (MPU) in this embodiment, is capable of controlling a register of the DSP 210d to maintain the functionalities of the identification unit 212 and the sinusoidal wave generator 214. The method of the present invention is described as follows:

Step 10: Obtain the output signal 116 utilizing the feedforward compensator 210, where the dominant signal Sd within the output signal 116 is a periodic sinusoidal wave corresponding to the tracking error or the focusing error of the disk drive 200, and the frequency of the dominant signal Sd is a rotational frequency of the disk drive 200.

Step 20: Identify a waveform of the dominant signal Sd utilizing the identification unit 212 according to a function generator (FG) signal 208 generated by the disk drive 200, where the identification unit 212 is capable of identifying waveform parameters of the dominant signal Sd within the output signal 116, deriving the rotational frequency of the disk drive 200 according to the FG signal 208, and outputting identification results such as the waveform parameters of the dominant signal Sd mentioned above or the rotational frequency to the sinusoidal wave generator 214.

Step 30: Generate a correction signal 216 utilizing the sinusoidal wave generator 214 according to the waveform of the dominant signal Sd and the FG signal 208. In this embodiment, the sinusoidal wave generator 214 is capable of determining waveform parameters of the correction signal 216 according to the identification results generated by the identification unit 212.

Step 40: Superpose the correction signal 216 on the output signal 116 utilizing the superposing unit 220 to correct the phase delay of the dominant signal Sd, and convert the output signal 116 into an output signal 218 correspondingly.

Step 50: Output the output signal 218 to the R/W module 120 utilizing the superposing unit 220 to control a tracking position or a focusing position of the R/W module 120.

Step 60: Detect runout or wobble of the optical disk 102 utilizing the feedforward compensator 210 according to the amplitude of the dominant signal Sd, where the identification results generated by the identification unit 212 at least include the amplitude of the dominant signal Sd.

In the first embodiment, the identification results generated by the identification unit 212 include the frequency, the phase, the amplitude, and the direct current (DC) offset of the dominant signal Sd, and the correction signal 216 generated by the sinusoidal wave generator 214 has the same frequency and the same phase as the dominant signal Sd.

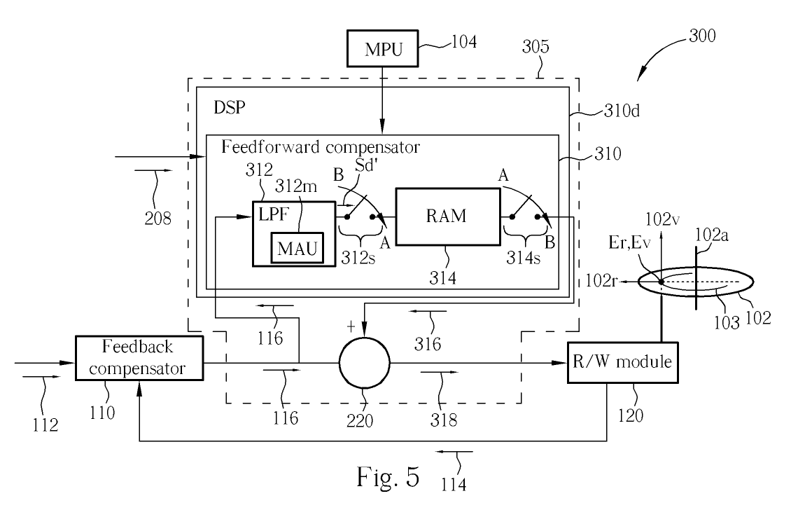

A second embodiment is disclosed in the following. Please refer to FIG. 3 and FIG. 5. FIG. 5 illustrates a feedforward compensation loop 305 corresponding to the method shown in FIG. 3 and operation thereof according to the second embodiment, where the disk drive 300 shown in FIG. 5 comprises the aforementioned feedback compensator 110 and the R/W module 120, which have already been explained utilizing FIG. 1 and FIG. 2

As shown in FIG. 5, the feedforward compensation loop 305 of this embodiment comprises a feedforward compensator 310 and the superposing unit 220 mentioned above. The feedforward compensator 310 comprises a low pass filter (LPF) 312, a memory such as a random access memory (RAM) 314, and logic units 312s and 314s, where the LPF 312, the RAM 314, and the logic units 312s and 31 4s are implemented utilizing a DSP 310d in this embodiment. The feedforward compensator 310 further comprises a moving average unit (MAU) 312m, which is positioned in the LPF 312 in this embodiment. Within the disk drive 300, the MPU 104 is capable of controlling a register of the DSP 310d to maintain the functionalities of the LPF 312, the RAM 314, and the logic units 312s and 314s. In the following, Steps 10′, 20′, . . . , 60′ of the second embodiment respectively correspond to Steps 10, 20, . . . , 60 of the flowchart shown in FIG. 3, where the order of Steps 10′, 20′, . . . , 60′ is not limited to the order detailed below. The method according to the second embodiment is described as follows.

Step 10′: Obtain the output signal 116 utilizing the feedforward compensator 310, where the dominant signal Sd within the output signal 116 is a periodic sinusoidal wave corresponding to the tracking error or the focusing error of the disk drive 300, and the frequency of the dominant signal Sd is a rotational frequency of the disk drive 300.

Step 20′: Identify a waveform of the dominant signal Sd utilizing the LPF 312, the logic unit 312s, and the RAM 314 according to the FG signal 208. In this step, firstly utilize the LPF 312 to perform low pass filtering on the output signal 116 to generate a low pass signal Sd′ corresponding to the waveform of the dominant signal Sd, where the low pass signal Sd′ shown in FIG. 5 is a result obtained from the moving average operation performed by the MAU 312m, i.e. a reconstructed waveform of the dominant signal Sd. When the logic units 312s and 314s are at State A, the feedforward compensator 310 samples the low pass signal Sd′, which is the reconstructed waveform of the dominant signal Sd, and sample information thereof is stored in the RAM 314.

Step 30′: Generate a correction signal 316 utilizing the RAM 314 and the logic unit 314s according to the FG signal 208 and the low pass signal Sd′. In this step, the correction signal 316 is generated according to the sample information stored in the RAM 314. When the logic units 312s and 314s are at State B, the logic unit 314s outputs the correction signal 316.

Step 40′: Superpose the correction signal 316 on the output signal 116 utilizing the superposing unit 220 to correct the phase delay of the dominant signal Sd, and convert the output signal 116 into an output signal 318 correspondingly.

Step 50′: Output the output signal 318 to the R/W module 120 utilizing the superposing unit 220 to control a tracking position or a focusing position of the R/W module 120.

Step 60′: Detect runout or wobble of the optical disk 102 utilizing the feedforward compensator 310 according to the amplitude of the low pass signal Sd′, which is the reconstructed waveform of the dominant signal Sd. As the reconstructed waveform of the dominant signal Sd is generated in Step 20′ and the sample information thereof is stored in the RAM 314, the feedforward compensator 310 is capable of calculating the amplitude of the reconstructed waveform of the dominant signal Sd according to the sample information stored in the RAM 314.

In the second embodiment, the moving average operation is utilized for reducing the fluctuation that would probably occur in the dominant signal Sd, so the reconstructed waveform of the dominant signal Sd, i.e. the low pass signal Sd′ generated in Step 20′, will be more credible. In addition, the frequency of the correction signal 316 generated in Step 30′ corresponds to the frequency of the low pass signal Sd′ generated in Step 20′, i.e. the rotational frequency of the disk drive 300.

According to this embodiment, the operation of the logic unit 314s and the operation of the logic unit 312s are enabled/disabled alternatively. When the logic unit 314s starts its operation of outputting the correction signal 316, the logic unit 312s stops its operation of storing the reconstructed waveform of the dominant signal Sd, i.e. the waveform information of the low pass signal Sd′, in the RAM 314. Conversely, when the logic unit 314s stops its operation of outputting the correction signal 316, the logic unit 312s starts its operation of storing the reconstructed waveform of the dominant signal Sd in the RAM 314. In another embodiment of the present invention, the operation of the logic unit 312s is continuously enabled. Yet in another embodiment of the present invention, it is not necessary to install the logic unit 314s, as the RAM 314 can be utilized for continuously storing the reconstructed waveform of the dominant signal Sd, i.e. the waveform information of the low pass signal Sd′.

In contrast to the related art, when the feedback compensator 110 superposes the dominant signal Sd (which can be utilized for correcting the tracking error or the focusing error) on the position driving signal 112 to generate the output signal 116, the present invention methods and the feedforward compensation loops 205 and 305 are capable of correcting the phase delay of the dominant signal Sd. As a result, the aforementioned situation where the feedback compensator 110 cannot bring the compensation ability into full play in real time due to the phase delay phenomenon will never occur, and neither will the improper compensation. Therefore, the compensation ability of the feedback compensator 110 to correct the tracking error or the focusing error is improved.

What is claimed is:

1. A method for tracking and focusing enhancement of disk drives, the method being utilized for performing feedforward compensation for a first output signal generated by a feedback compensator of a disk drive, the first output signal being utilized for controlling a tracking position or a focusing position of a read/write (R/W) module of the disk drive, the method comprising:
(a) obtaining the first output signal, within which a dominant signal is a periodic wave corresponding to a tracking error or a focusing error of the disk drive;
(b) identifying a waveform of the dominant signal;
(c) generating a correction signal according to the waveform of the dominant signal; and
(d) superposing the correction signal on the first output signal to correct the dominant signal.

2. The method of claim 1, wherein the dominant signal is a periodic sinusoidal wave whose frequency is a rotational frequency of the disk drive, step (b) further comprises identifying the frequency, the phase, the amplitude, and the direct current (DC) offset of the dominant signal according to a function generator (FG) signal of the disk drive, and the correction signal has the same frequency as the rotational frequency and the same phase as that of the dominant signal.

3. The method of claim 1, wherein step (d) further comprises converting the first output signal into a second output signal, and the method further comprises:
outputting the second output signal to the R/W module to control the tracking position or the focusing position of the R/W module.

4. The method of claim 1, further comprising:
detecting runout or wobble of a disk in the disk drive according to the amplitude of the dominant signal.

5. The method of claim 1, wherein the frequency of the dominant signal is a rotational frequency of the disk drive, step (b) further comprises sampling the waveform of the dominant signal according to a function generator (FG) signal of the disk drive and storing sample information thereof, step (c) further comprises generating the correction signal according to the sample information stored in step (b), and the correction signal has the same frequency as the rotational frequency.

6. The method of claim 1, wherein step (b) further comprises performing low pass filtering on the first output signal to correspondingly generate a reconstructed waveform of the dominant signal, and step (c) further comprises generating the correction signal according to the reconstructed waveform generated in step (b).

7. The method of claim 6, wherein step (b) further comprises performing a moving average operation to generate the reconstructed waveform of the dominant signal.

8. The method of claim 1, wherein the disk drive is an optical disk drive.

9. A device for tracking and focusing enhancement of disk drives, the device being utilized for performing feedforward compensation for a first output signal generated by a feedback compensator of a disk drive, the first output signal being utilized for controlling a tracking position or a focusing position of a read/write (R/W) module of the disk drive, within the first output signal being a dominant signal, which is a periodic wave corresponding to a tracking error or a focusing error of the disk drive, the device comprising:
a identification unit coupled to the feedback compensator for identifying a waveform of the dominant signal;
a sinusoidal wave generator coupled to the identification unit for generating a correction signal according to the waveform of the dominant signal; and
a superposing unit coupled to the feedback compensator and the sinusoidal wave generator for superposing the correction signal on the first output signal to correct the dominant signal.

10. The device of claim 9, wherein the frequency of the dominant signal is a rotational frequency of the disk drive, the identification unit identifies the frequency, the phase, the amplitude, and the direct current (DC) offset of the dominant signal according to a function generator (FG) signal of the disk drive, and the correction signal has the same frequency as the rotational frequency and the same phase as that of the dominant signal.

11. The device of claim 9, wherein the superposing unit converts the first output signal into a second output signal, and outputs the second output signal to the R/W module to control the tracking position or the focusing position of the R/W module.

12. The device of claim 9, wherein both the identification unit and the sinusoidal wave generator are formed with a digital signal processor (DSP), and the device further comprises:
a microprocessor for controlling a register of the DSP to maintain the functionalities of the identification unit and the sinusoidal wave generator.

13. The device of claim 9, wherein the disk drive is an optical disk drive.

14. A device for tracking and focusing enhancement of disk drives, the device being utilized for performing feedforward compensation for a first output signal generated by a feedback compensator of a disk drive, the first output signal being utilized for controlling a tracking position or a focusing position of a read/write (R/W) module of the disk drive, within the first output signal being a dominant signal, which is a periodic wave corresponding to a tracking error or a focusing error of the disk drive, the device comprising:
a low pass filter (LPF) coupled to the feedback compensator for generating a low pass signal according to the first output signal;
a memory coupled to the LPF for storing waveform information of the low pass signal;
a first logic unit coupled to the memory for outputting a correction signal, wherein the correction signal corresponds to the waveform information stored in the memory; and
a superposing unit coupled to the feedback compensator and the first logic unit for superposing the correction signal on the first output signal to correct the phase delay of the dominant signal.

15. The device of claim 14, further comprising:
a second logic unit coupled to the LPF and the memory for controlling the operation of storing the waveform information of the low pass signal into the memory.

16. The device of claim 14, wherein the frequency of the dominant signal is a rotational frequency of the disk drive, and the device stores the waveform information of the low pass signal according to a function generator (FG) signal of the disk drive.

17. The device of claim 14, wherein the superposing unit converts the first output signal into a second output signal, and outputs the second output signal to the R/W module to control the tracking position or the focusing position of the R/W module.

18. The device of claim 14, wherein the LPF, the memory, and the first logic unit are formed with a digital signal processor (DSP), and the device further comprises:
a microprocessor for controlling a register of the DSP to maintain the functionalities of the LPF, the memory, and the first logic unit.

19. The device of claim 14, further comprising:
a moving average unit coupled to the LPF for performing a moving average operation on the low pass signal.

20. The device of claim 14, wherein the disk drive is an optical disk drive.
